(19) United States
(12) Patent Application Publication
(10) Pub. No.: US 2026/0002659 A1
(43) Pub. Date: Jan. 1, 2026

(54) RECESSED LIGHTING DEVICE AND HOUSEHOLD APPLIANCE INCLUDING SAID RECESSED LIGHTING DEVICE

(71) Applicant: SMEG S.P.A., GUASTALLA (RA) (IT)

(72) Inventors: Martina GOBBI, GUASTALLA (RE) (IT); Mauro LORENZANI, GUASTALLA (RE) (IT); Pietro BARTESELLI, MARON DI BRUGNERA (PN) (IT)

(73) Assignee: SMEG S.P.A., GUASTALLA (RA) (IT)

(21) Appl. No.: 19/181,448

(22) Filed: Apr. 17, 2025

(30) Foreign Application Priority Data
Apr. 19, 2024 (IT) 102024000009031

(51) Int. Cl. F21V 17/10; F21V 3/04; F21V 21/04; F21Y 103/10; F21Y 115/10; F25D 27/00

(52) U.S. Cl. CPC F21V 17/105; F21V 3/049; F21V 21/04; F25D 27/00; F21Y 2103/10; F21Y 2115/10

(57) ABSTRACT

A recessed lighting device extends along a longitudinal axis and comprises:
a frame;
a reflector extending along the longitudinal axis, which is supported by the frame and is provided with a wall between two longitudinal reflector edges and defining a concave surface, which is at least partially reflective;
a diffuser extending along the longitudinal axis, which is supported by the frame and faces the concave surface of the reflector;
a source assembly supported by the frame and configured to generate at least one light beam to light the concave surface of the reflector; the source assembly comprising at least one linear light source arranged along one of the longitudinal reflector edges.

### CROSS-REFERENCE TO RELATED APPLICATIONS

This patent application claims priority from Italian patent application no. 102024000009031 filed on Apr. 19, 2024, the entire disclosure of which is incorporated herein by reference.

### TECHNICAL FIELD

This invention relates to a recessed lighting device. In particular, this invention relates to a recessed lighting device, preferably suitable for a refrigerator, and to a refrigerator comprising said recessed lighting device.

The technical field of this invention relates to recessed lighting systems for interior lighting of household appliances and/or furniture.

In particular, the recessed lighting device according to this invention is particularly suitable for the interior of household lighting appliances, without, however, excluding the applicability of the invention claimed to the furniture sector too for the interior lighting of furniture.

### BACKGROUND

It is known to use recessed light sources to light internal parts of household appliances (such as refrigerators, wine coolers, dryers, ovens, etc.).

In refrigerators and wine coolers, in particular, several light sources distributed within the cooling chamber are often used in order to enable homogeneous and effective lighting of the food and beverages arranged within the cooling chamber.

Different light sources are often used due to the reduced efficiency of the sources used. Available space and limit operating conditions the use of efficient, commercially available sources.

In addition, the sources used are often not of the recessed type and occupy useful space in the cooling chamber.

### DESCRIPTION OF THE INVENTION

It is, therefore, one purpose of this invention to provide a recessed lighting device that is free from the prior art drawbacks noted herein; in particular, it is one purpose of the invention to provide a recessed lighting device that allows the above drawbacks to be overcome in a simple and inexpensive manner, both from the functional and the constructional point of view.

In accordance with these purposes, this invention relates to a recessed lighting device extending along a longitudinal axis and comprising:
a frame;
a reflector extending along the longitudinal axis, which is supported by the frame and is provided with a between two longitudinal reflector edges and defining a concave surface, which is at least partially reflective;
a diffuser extending along the longitudinal axis, which is supported by the frame and faces the concave surface of the reflector;
a source assembly supported by the frame and configured to generate at least one light beam to light the concave surface of the reflector; the source assembly comprising at least one linear light source arranged along one of the longitudinal reflector edges.

Another purpose of the invention is to provide an appliance that is equipped with at least one recessed lighting device to ensure an effective lighting level.

In accordance with these purposes, this invention relates to an appliance as claimed in claim 12.

### BRIEF DESCRIPTION OF THE DRAWINGS

Further features and advantages of this invention will be apparent from the following description of a non-limiting embodiment thereof, with reference to the figures of the accompanying drawings, wherein:

FIG. 1 is a perspective view, with parts removed for clarity, of a portion of a household appliance comprising the lighting device according to this invention;

FIG. 2 is a perspective view of the lighting device according to this invention;

FIG. 3 is a prospective cross-section view, with parts removed for clarity, of a portion of the lighting device according to this invention;

FIG. 4 is a cross-section view from above of the portion of the lighting device in FIG. 3;

FIG. 5 is a perspective view with exploded parts of a detail of the refrigerator from FIG. 1;

FIG. 6 is a perspective view of the detail of the refrigerator from FIG. 5.

### DESCRIPTION OF ONE EMBODIMENT OF THE INVENTION

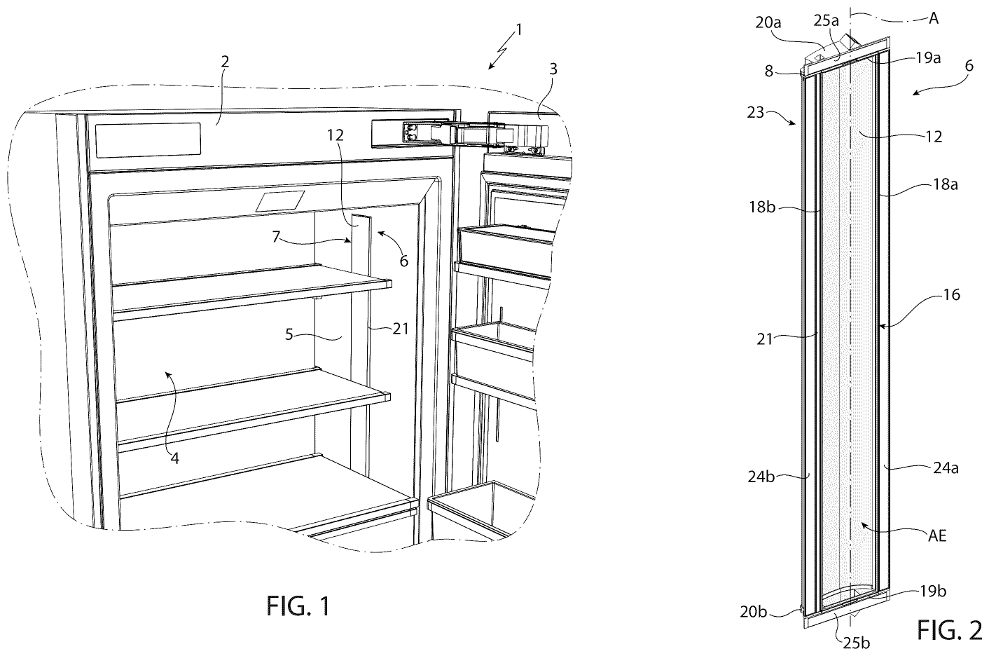

Referring to the attached figures, FIG. 1 shows a portion of a household appliance 1.

In the example described and illustrated herein, the household appliance 1 is a refrigerator. Similar considerations can be made for wine coolers or wine fridges.

The refrigerator 1 has a main body 2 with an inner chamber 4 dedicated to cooling (partly visible in FIG. 1) and a door 3 hinged to the main body 2 to selectively close the chamber 4.

The refrigerator 1 is equipped with at least one lighting device 6 arranged along a respective wall 5 of the chamber 4.

In the example described and illustrated herein, the refrigerator 1 comprises two lighting devices 6 according to this invention and arranged on respective side walls 5 of the chamber 4. In particular, the lighting devices 6 are recessed and are arranged in the respective grooves 7 of the wall 5. “Recessed lighting device” means, here and hereafter, that the lighting device is arranged basically flush with one of the walls 5 defining the chamber 4 without occupying substantial (i.e. non-negligible) space within the chamber 4.

The chamber 4 is usually equipped with multiple supports for storing food and beverages.

Each lighting device 6 extends longitudinally along the respective side wall 5 of the chamber 4 for almost the entire height of the side wall 5 so as to face several supports of the refrigerator 1. It is understood that the dimensions of each lighting device 6 and the number of lighting devices 6 arranged within chamber 4 may vary depending on the type of application and user requirements.

A variant not illustrated requires that the lighting devices be recessed into the respective grooves of at least one wall of a chamber of a furniture element. For example, the lighting device according to this invention can be applied to one of the inside walls of a wardrobe to light the clothing contained therein.

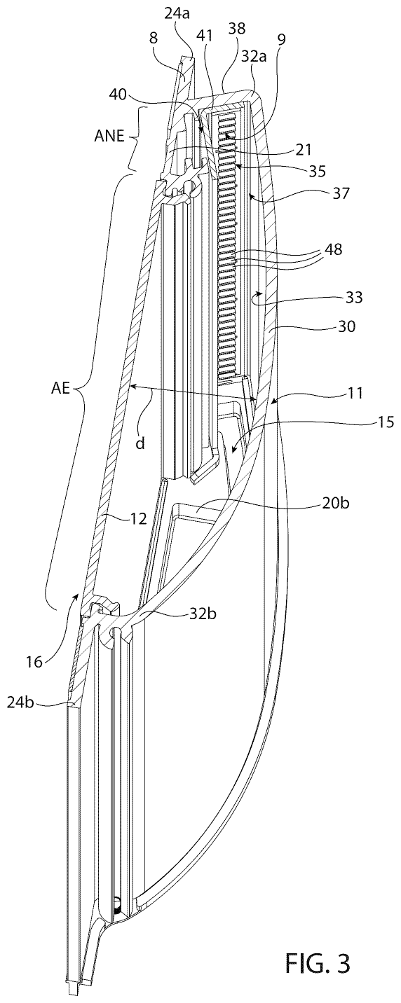

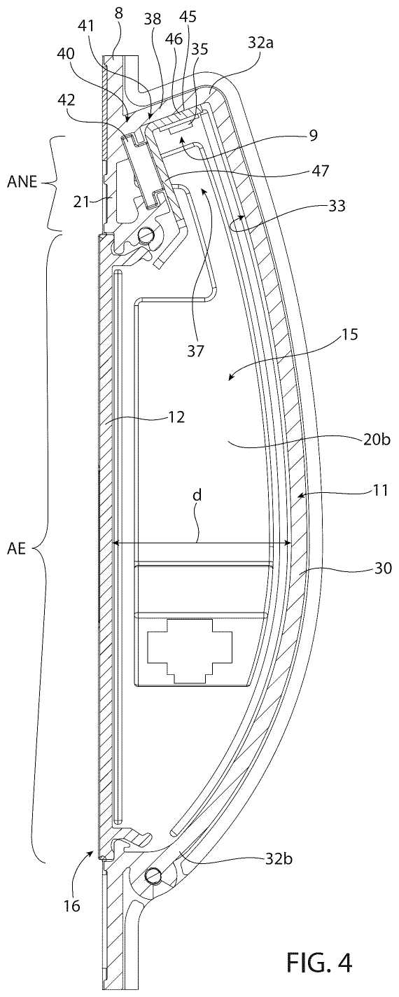

With reference to FIG. 2, the lighting device 6 extends along a longitudinal axis A and comprises a frame 8, a source assembly 9 (best seen in FIGS. 3 and 4), a reflector 11 (best seen in FIGS. 3 and 4) and a diffuser element 12.

The frame 8 is configured to support, as we shall see in detail below, the source assembly 9, reflector 11 and diffuser element 12.

The frame 8 is also configured to be coupled to the wall 5 of the refrigerator 1 in the respective groove 7 of the wall 5.

With reference to FIGS. 2 and 3, the frame 8 and the reflector 11 are arranged in such a way as to define an emission chamber 15 provided with a longitudinal emission aperture 16.

The source assembly 9 is housed in the emission chamber 15.

In particular, the frame 8 supports the reflector 11 in such a way that the reflector 11 defines at least one inner wall of the emission chamber 15.

The longitudinal emission aperture 16 essentially defines the emissive area AE of the lighting device 6. The aperture 16 is engaged by the diffuser 12.

The diffuser 12 is preferably planar and is preferably defined by an opal plastic element.

The aperture 16 is preferably sized and positioned relative to the wall 5 in such a way that the emissive area AE is contained within the free area defined by the respective groove 7 of the wall 5.

In the specific example illustrated here, as we shall see shortly, the emissive area AE of the lighting device 6 is essentially equal to the free area defined by the respective groove 7 of the wall 5.

The frame 8 actually comprises two longitudinal edges 18a, 18b and two transverse edges 19a, 19b that delimit the emission aperture 16.

At the transverse edges 19a, 19b, the frame is also provided with two respective closing elements 20a, 20b (both visible in FIG. 2) shaped to close the emission chamber 15 at its longitudinal ends.

The frame 8 is shaped so as to define, at least along a longitudinal edge 19a of the frame 9, a cover element 21.

The cover element 21 extends longitudinally, and preferably for the entire longitudinal extension of the longitudinal edge 19a, to define a longitudinal non-emissive area ANE alongside the longitudinal emissive area AE defined by the diffuser element 12.

The frame 8 also comprises a coupling frame 23, which is defined by two longitudinal coupling tongues 24a, 24b, which project from the cover element 21 (or longitudinal edge 18a if cover element 21 is present) and longitudinal edge 18b in the opposite direction to the opening 16, and two transverse coupling tongues 25a, 25b, which project from respective transverse edges 19a, 19b in the opposite direction to the aperture 16.

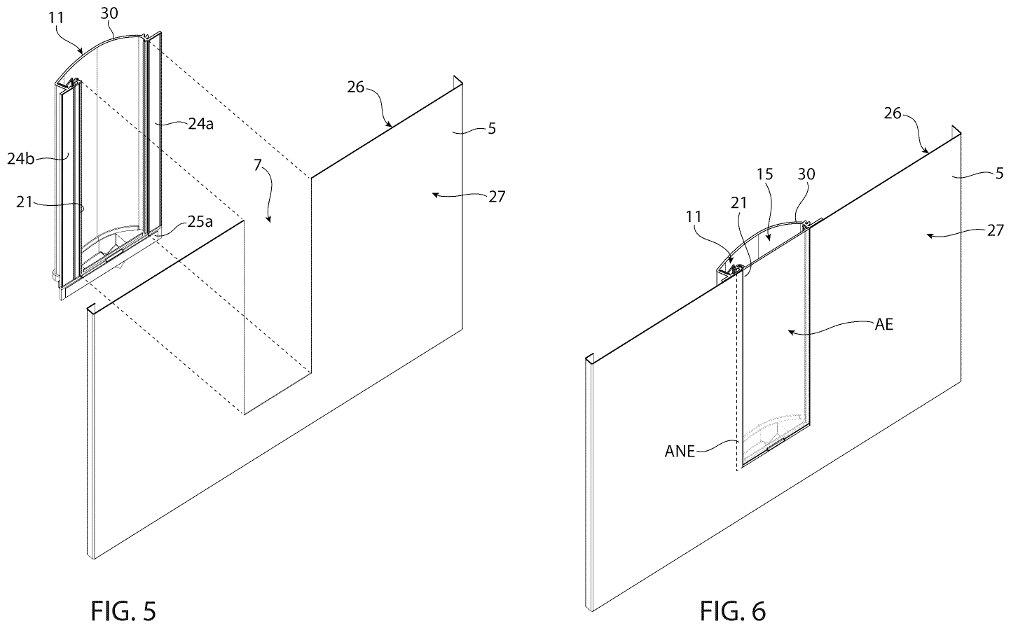

With reference to FIGS. 5 and 6, the longitudinal coupling tongues 24a, 24b and the transverse coupling tongues 25a, 25b are coupled, in use, to an inner face 26 of the wall 5 of the refrigerator 1 by means of coupling means (adhesive couplings, interference couplings, etc.).

In particular, the longitudinal coupling tongues 24a, 24b and transverse coupling tongues 25a, 25b are coupled to the inner face 26 of the wall 5 along the perimeter of the groove 7 of the wall 5, such that the groove 7 is substantially engaged by the diffuser element 12 and, preferably, such that the cover element 21 is covered by the wall 5. In other words, the cover element 21 is not visible through the groove 7 of the wall 5.

The diffuser element 12 and cover element 21 are preferably planar. The frame 8 is configured in such a way that the diffuser element 12 is substantially flush with an outer face 27 of the wall 5, when the frame 8 is coupled to the wall 5 of the refrigerator 1 (also see the views in FIGS. 3 and 4).

With reference to the use configuration of FIG. 6, therefore, the aperture 16 is sized to have substantially the same height (measured along the longitudinal axis A) as the groove 7 of the wall 5 and the same width (measured along a direction transverse to the longitudinal axis A) as the groove 7 of the wall 5.

Any differences in height and/or width may be due to the type of coupling used to couple the diffuser 12 to the frame 8 and can be considered negligible.

With reference to FIGS. 3 and 4, the reflector 11 is supported by the frame 8 and is provided with a longitudinal wall 30 with two longitudinal reflector edges 32a, 32b. The wall 30 defines a concave surface 33 between the longitudinal reflector edges 32a, 32b and facing the emission aperture 16.

The reflector 11 is shaped in such a way that the arc defined by the concave surface 33 subtends the emissive area AE of the aperture 16 and the non-emissive area ANE of the cover element 21.

As it is arranged laterally with respect to the emissive area AE, the non-emissive area ANE is subtended by an end portion of the concave surface 33 of the reflector 11. In the example described and illustrated herein, the end portion of the concave surface 33 facing the cover element 21 is the one proximal to the longitudinal reflector edge 32a.

The concave surface 33 is at least partially reflective and preferably has a parabolic profile.

The concave surface 33 is preferably made reflective by coating it with a reflective material.

The wall 30 preferably follows the concave profile of the concave surface 33.

The concave surface 33 is preferably shaped in such a way that the maximum distance d between the concave surface 33 and diffuser 12 is less than 3 cm, preferably 2.5 cm. This configuration results in a very small overall footprint, in terms of depth, with obvious advantages in terms of freedom of installation in appliances with very limited internal space around the chamber 4 for housing the recessed lighting devices.

The longitudinal portions of the frame 8 and the reflector 11 are preferably made of one piece, for example by extrusion.

The source assembly 9 is housed in the emission chamber 15 and is configured to generate at least one light beam to light the concave surface 33 of the reflector 11.

The source assembly 9 comprises at least one linear light source 35, which is arranged along one of the longitudinal reflector edges 32a, 32b of the reflector 11. In other words, the linear light source 35 is arranged near one of the longitudinal reflector edges 32a, 32b following its longitudinal shape.

The linear light source 35 is preferably arranged along the longitudinal reflector edge 32a proximal to the end portion of the concave surface 33 facing the cover element 21.

Specifically, the frame 8 is shaped so as to define a housing 37 seat near the longitudinal reflector edge 32a proximal to the end portion of the concave surface 33 facing the cover element 21.

The housing 37 seat, in essence, is a seat bounded by the cover element 21, the longitudinal reflector edge 32a and, preferably, a support wall 38 of the frame 8 extending between the longitudinal reflector edge 32a and the cover element 21. The support wall 38 of the frame 8 extends transversally to the longitudinal reflector edge 32a.

The support wall 38 of the frame 8 preferably extends orthogonally to the longitudinal reflector edge 32a. In other words, the angle formed between the support wall 38 and the longitudinal reflector edge 32a is approximately 90°.

The source assembly 9 is preferably coupled to the frame 8 in such a way that the linear source 35 is arranged substantially along the support wall 38.

The arrangement of the support wall 38 therefore determines the position of the linear source 35.

The support wall 38, as mentioned earlier, is preferably arranged transverse to the longitudinal reflector edge 32a. The orientation of the support wall 38 is preferably such as to define a position of the linear source 35 that optimises the amount of the light beam emitted by the linear source 35 that is reflected by the concave reflective surface 33. In other words, the linear light source must face the concave reflective surface 33. The source assembly 9 is preferably coupled to the frame 8 via a magnetic coupling system 40.

The magnetic coupling system 40 comprises a linear support element 41 configured to support the at least one linear light source 35 and at least one coupling element 42 fixed to the frame 8.

Either the coupling element 42 or the linear support element 41 is made, at least in part, of a magnetic material; the other of the coupling element 42 and the linear support element 41 is made, at least in part, of a metallic material capable of attracting the magnetic material.

In the non-limiting example described and illustrated here, the linear support element 41 is made of a metallic material and the coupling element 42 is defined by a magnet coupled to the frame 8. In the example described herein, the coupling system 40 comprises multiple coupling elements 42 arranged at a distance from each other along a longitudinal path and fixed to the frame 8. The coupling elements 42 are preferably fixed to the frame 8, for example by means of fastening systems (not illustrated) or by interference in grooves made in the frame 8.

In the embodiment described and illustrated herein, the linear support element 41 is preferably defined by a longitudinal plate 45 comprising a first portion 46, coupled to the linear light source 35, and a second portion 47, arranged transversely to the first portion 46 and coupled to the frame 8 by means of the magnetic coupling system 40 comprising the at least one coupling element 42.

The first portion 46 and the second portion 47 are preferably orthogonal to each other to define an essentially “L-shaped” plate.

The coupling elements 42 are fixed to the cover element 21 and, in particular, to the inner face of the cover element 21 facing the emission chamber 15 and the concave surface 33.

This facilitates the removal and/or positioning of the source assembly 9 during installation or maintenance work. The user can actually move the linear support element 41 (and the linear source 35 coupled thereto) and obtain the correct coupling and positioning quickly thanks to the magnetic attraction determined by the multiple coupling elements 42 distributed, for example, along the inner face of the cover element 21. Advantageously, the user can also act on the portion 47 not occupied by the linear light source 35 to move the linear support element 41 without running any risk of damaging the linear light source 35. The operation of removing and mounting the linear support element 41 is actually normally carried out by the user without being able to fully view the access area due to the normal positioning of the lighting device.

According to a variant not shown, the coupling elements can be fixed to the support wall 38.

The linear light source 35 comprises multiple aligned light elements 48. The light elements can be LEDs or laser diodes.

According to one variant not shown, the linear light source may comprise a longitudinal light guide and at least one LED source coupled to one end of the light guide. The LED source, for example, can be arranged outside the emission chamber.

Advantageously, the source assembly 9 is housed in the housing 37 seat and cannot be seen by the user especially if the cover element 21 is arranged in the groove 7 in a position proximal to the door 3 of the refrigerator 1 (or proximal to the normal position of the user using the appliance if the appliance is not a refrigerator).

In this way, the light emitted by the lighting device is homogeneous and diffuse without being directly visible. In addition, the presence of the longitudinal reflector 11 makes the lighting of the chamber 4 even more effective.

According to a variant not shown, the lighting device may comprise two linear sources, arranged along the respective longitudinal reflector edges.

Lastly, it is clear that modifications and variations may be made to the lighting device and household appliance described and illustrated herein without departing from the scope of this invention, as set forth in the appended claims.

1. A recessed lighting device (6) extending along a longitudinal axis (A) and comprising:
a frame (8);
a reflector (11) extending along the longitudinal axis (A), which is supported by the frame (8) and is provided with a wall (30) between two longitudinal reflector edges (32a, 32b) and defining a concave surface (33), which is at least partially reflective;
a diffuser (12) extending along the longitudinal axis (A), which is supported by the frame (8) and faces the concave surface (33) of the reflector (11);
a source assembly (9) supported by the frame (8) and configured to generate at least one light beam to illuminate the concave surface (33) of the reflector (11); the source assembly (9) comprising at least one linear light source (35) arranged along one of the longitudinal edges of the reflector (32a, 32b).

2. The device according to claim 1, wherein the source assembly (9) is coupled to the frame (8) by means of a magnetic coupling system (40).

3. The device according to claim 2, wherein the magnetic coupling system (40) comprises a linear support element (41) configured to support the at least one linear light source (35) and at least one coupling element (42) fixed to the frame (8); one between the coupling element (42) and the linear support element (41) being made, at least in part, of a magnetic material; the other between the coupling element (42) and the linear support element (41) being made, at least in part, of a metallic material capable of attracting the magnetic material.

4. The device according to claim 3, wherein the linear support element (41) comprises a longitudinal plate (45) comprising a first portion (46), coupled to the linear light source (35), and a second portion (47) arranged transversely to the first portion (46) and coupled to the frame (8) by means of the at least one coupling element (42).

5. The device according to claim 1, wherein the frame (8) and the reflector (11) are configured so as to define an emission chamber (15) having a longitudinal emission aperture; the diffuser (12) being configured so as to close the longitudinal emission aperture (16) to define a longitudinal emissive area (AE).

6. The device according to claim 5, wherein the source assembly (9) is housed, at least in part, in the emission chamber (15).

7. The device according to claim 5, wherein the frame (8) is configured to define a cover element (21), which extends along a longitudinal edge (19a; 19b) of the longitudinal emission aperture (16) to define a longitudinal non-emissive area (ANE) flanking the emissive area (AE).

8. The device according to claim 7, wherein the at least one linear light source (35) is arranged along the longitudinal reflector edge (32a) proximal to an end portion of the concave surface (33) facing the cover element (21).

9. The device according to claim 1, wherein the diffuser (12) is planar.

10. Device according to claim 1, wherein the longitudinal portions of the frame (8) and the reflector (11) consist of a single body, preferably extruded.

11. The device according to claim 1, wherein the linear light source (35) comprises a plurality of aligned light elements (38).

12. A household appliance, preferably a refrigerator, comprising an inner chamber (4) defined by several walls (5) and a recessed lighting device (6) as claimed in claim 1; the lighting device (6) being arranged recessed in at least one of the walls (5) to illuminate the inner chamber (4).

13. The appliance according to claim 12, wherein the at least one of the walls (5) is provided with a groove (7), which is engaged by the lighting device (6); wherein the frame (8) and the reflector (11) of the lighting device (6) are configured to define an emission chamber (15) provided with a longitudinal emission aperture (16); the diffuser (12) being configured to close the longitudinal emission aperture (16) to define a longitudinal emissive area (AE); the longitudinal emission aperture (16) being sized and positioned with respect to the wall (5) such that the emissive area (AE) is contained in the free area defined by the respective groove (7) of the wall (5).

14. The appliance according to claim 12, wherein the emissive area (AE) is substantially identical to the free area defined by the respective groove (7) of the wall (5).

15. Appliance according to claim 13, wherein the linear light source (35) is arranged along the longitudinal reflector edge (32a, 32b) which is arranged in a position proximal to the position the user normally assumes when using the appliance.
